(19) United States
(12) Patent Application Publication
(10) Pub. No.: US 2018/0049260 A1
(43) Pub. Date: Feb. 15, 2018

(54) APPARATUS AND METHOD FOR PROXIMITY-BASED SERVICE COMMUNICATION

(71) Applicant: NEC Corporation, Tokyo (JP)

(72) Inventors: Hiroaki AMINAKA, Tokyo (JP); Hiroto SUGAHARA, Tokyo (JP)

(21) Appl. No.: 15/556,230

(22) PCT Filed: Nov. 18, 2015
(86) PCT No.: PCT/JP2015/005749

§ 371 Date: Sep. 6, 2017

(30) Foreign Application Priority Data
Mar. 6, 2015 (JP) 2015-045184

(51) Int. Cl. H04W 76/02; H04W 56/00; H04W 8/00; H04W 72/04

(52) U.S. Cl. CPC H04W 76/023; H04W 72/0406; H04W 72/048; H04W 56/002; H04W 8/005; H04W 72/14

(57) ABSTRACT

A radio terminal (1) is configured to, in response to receiving a request from a network (100) when the radio terminal (1) can connect to the network (100), perform sidelink communication (102) with a second radio terminal (2), which is in a state of being unable to connect to the network (100), in accordance with a pre-configured first radio parameter (1008). The sidelink communication (102) includes at least one of direct discovery and direct communication. It is thus, for example, possible to contribute to improvement of sidelink communication in partial coverage.

### TECHNICAL FIELD

The present application relates to Proximity-based services (ProSe) and, in particular, to direct discovery and direct communication that are performed by using a direct interface between radio terminals.

### TECHNICAL FIELD

The 3GPP Release 12 specifies Proximity-based services (ProSe) (see, for example, Non-patent Literature 1). ProSe includes ProSe discovery and ProSe direct communication, ProSe discovery makes it possible to detect proximity of radio terminals. ProSe discovery includes direct discovery (ProSe Direct Discovery) and network-level discovery (EPC-level ProSe Discovery).

ProSe Direct Discovery is performed through a procedure in which a radio terminal capable of performing ProSe (i.e., ProSe-enabled UE) detects another ProSe-enabled UE by using only the capability of a radio communication technology (e.g., Evolved Universal Terrestrial Radio Access (E-UTRA) technology) possessed by these UEs. On the other hand, in EPC-level ProSe Discovery, a core network (i.e., Evolved Packet Core (EPC)) determines proximity of two ProSe-enabled UEs and notifies these UEs of detection of proximity. ProSe Direct Discovery may be performed by three or more ProSe-enabled UEs.

ProSe direct communication enables establishment of a communication path between two or more ProSe-enabled UEs existing in a direct communication range after the ProSe discovery procedure is performed. In other words, ProSe direct communication enables a ProSe-enabled UE to directly communicate with another ProSe-enabled UE, without communicating through a Public Land Mobile Network (PLMN) including a base station (eNodeB), ProSe direct communication may be performed by using a radio communication technology that is also used to access a base station (eNodeB) (i.e., E-UTRA technology) or by using a wireless local area network (WLAN) radio technology (i.e., IEEE 802.11 radio technology).

In 3GPP Release 12, a ProSe function communicates with a ProSe-enabled UE through a Public Land Mobile Network (PLMN) and assists ProSe discovery and ProSe direct communication. The ProSe function is a logical function that is used for PLMN-related operations required for ProSe. The functionality provided by the ProSe function includes, for example: (a) communication with third-party applications (a ProSe Application Server); (b) authentication of a UE for ProSe discovery and ProSe direct communication; (c) transmission of configuration information for ProSe discovery and ProSe direct communication (e.g., EPC-ProSe-User ID) to a UE; and (d) provision of network-level discovery (i.e., EPC-level ProSe discovery). The ProSe function may be implemented in one or more network nodes or entities. In this specification, one or more network nodes or entities that implement the ProSe function are referred to as a “ProSe function entity” or a “ProSe function server”.

As described above, ProSe direct discovery and ProSe direct communication are performed on an inter-UE direct interface. This direct interface is referred to as a PC5 interface or a sidelink, Hereinafter, in this specification, communication including at least one of direct discovery and direct communication is referred to as “sidelink communication”.

A UE needs to communicate with a ProSe function before performing sidelink communication (see Non-patent Literature 1). In order to perform ProSe direct communication and ProSe direct discovery, the UE has to communicate with the ProSe function and acquire authentication information by the PLMN from the ProSe function in advance. Further, in the case of ProSe direct discovery, the UE has to transmit a discovery request to the ProSe function. Specifically, when the UE desires transmission (announcement) of discovery information on the sidelink, the UE transmits to the ProSe function a discovery request for the announcement. On the other hand, when the UE desires reception (monitoring) of discovery information on the sidelink, the UE transmits to the ProSe function a discovery request for the monitoring. Then, when the discovery request has succeeded, the UE is permitted to transmit or receive the discovery information on the inter-UE direct interface (e.g., sidelink or PC5 interface).

The allocation of radio resources for the sidelink communication to n UE is performed by a radio access network (e.g., Evolved Universal Terrestrial Radio Access Network (E-UTRAN)) (see Non-patent Literatures 1 and 2). The UE which is permitted to perform the sidelink communication by the ProSe function performs ProSe direct discovery or ProSe direct communication by using radio resources configured by a radio access network node (e.g., eNodeB), Sections 23.10 and 23.11 of Non-patent. Literature 2 describe details of the allocation of radio resources for the sidelink communication to a UE.

Regarding ProSe direct communication, two resource allocation modes, i.e., Scheduled resource allocation and Autonomous resource selection are specified. In the Scheduled resource allocation for ProSe direct communication, a UE requests an eNodeB to allocate resources and the eNodeB schedules resources for sidelink control and data for the UE. Specifically, the UE sends to the eNodeB a scheduling request together with a ProSe Buffer Status Report (BSR).

On the other hand, in the Autonomous resource selection of ProSe direct communication, a UE autonomously selects resources for sidelink control and data from a resource pool(s). An eNodeB may allocate a resource pool(s) for the Autonomous resource selection to a UE in a System Information Block (SIB) 18. The eNodeB may allocate a resource pool for the Autonomous resource selection to a UE in Radio Resource Control (RRC)_CONNECTED via dedicated RRC signaling. This resource pool may be available when the UE is in RRC_IDLE.

Regarding ProSe direct discovery, two resource allocation modes, i.e., Scheduled resource allocation and Autonomous resource selection are also specified. In the Autonomous resource selection for ProSe direct discovery, a UE that desires transmission (announcement) of discovery information autonomously selects radio resources from a resource pool(s) for announcement. This resource poof is configured in UEs via broadcast (SIB 19) or dedicated signaling (RRC signaling).

In the Scheduled resource allocation for ProSe direct discovery, a UE requests an eNodeB to allocate resources for announcement via RRC signaling. The eNodeB allocates resources for announcement from a resource pool that is configured in UEs for monitoring. When the Scheduled resource allocation is used, the eNodeB indicates in SIB19 that it provides resources for monitoring of ProSe direct discovery but does not provide resources for announcement.

Furthermore, 3GPP Release 12 specifies a partial coverage scenario in which one UE is located out of the network coverage and the other UE is located in the network coverage (e.g., see Sections 4.4,3, 4.5,4 and 5,4.4 of Non-Patent Literature 1). In the partial coverage scenario, a UE that is out of coverage is referred to as a “remote UE” and a UE that is in coverage and acts as a relay between the remote UE and the network is referred to as a “ProSe UE-to-Network Relay”, The ProSe UE-to-Network Relay relays traffic (downlink and uplink) between the remote UE and the network (i.e., E-UTRAN and EPC). More specifically, the ProSe UE-to-Network Relay attaches to the network as a UE, establishes a PDN connection to communicate with a ProSe function entity or another Packet Data Network (PDN), and communicates with the ProSe function entity to start ProSe Direct Communication. The ProSe UE-to-Network Relay further performs the discovery procedure with the remote UE, communicates with the remote UE on the inter-UE direct interface (e.g., sidelink or PC5 interface), and relays traffic (downlink and uplink) between the remote UE and the network. When the Internet Protocol version 4 (IPv4) is used, the ProSe UE-to-Network Relay serves as a Dynamic Host Configuration Protocol Version 4 (DHCPv4) Server and Network Address Translation (NAT). When the IPv6 is used, the ProSe UE-to-Network Relay serves as a stateless DHCPv6 Relay Agent, In this specification, a radio terminal that has the ProSe function and the relay function such as the ProSe UE-to-Network Relay is herein referred to as a “relay radio terminal” or a “relay UE”, Further, a radio terminal that is served with the relay service by the relay radio terminal (relay UE) is hereinafter referred to as a “remote radio terminal” or a “remote UE”.

Note that 3GPP Release 12 ProSe is one example of proximity-based services (ProSe) that are provided based on geographic proximity of a plurality of radio terminals. Similarly to 3GPP Release 12 ProSe, the proximity-based service in a public land mobile network (PLMN) includes discovery and direct-communication phases assisted by a function or a node (e.g., ProSe function) located in the network. In the discovery phase, geographic proximity of radio terminals is determined or detected. In the direct communication phase, the radio terminals perform direct communication. The direct communication is performed between radio terminals in proximity to each other, without communicating through a public land mobile network (PLMN). The direct communication is also referred to as “device-to-device (D2D) communication” or “peer-to-peer communication”. In this specification, the term “ProSe” is not limited to 3GPP Release 12 ProSe and refers to proximity-based service communication including at least one of discovery and direct communication. Further, each of the terms “proximity-based service communication” and “ProSe communication” in this specification refers to at least one of the discovery and the direct communication.

The term “public land mobile network (PLMN)” in this specification indicates a wide-area radio infrastructure network, and means a multiple-access mobile communication system. The multiple-access mobile communication system enables mobile terminals to perform radio communication substantially simultaneously by sharing radio resources including at least one of time resources, frequency resources, and transmission power resources among the mobile terminals. Typical examples of multiple-access technology include Time Division Multiple Access (TDMA), Frequency Division Multiple Access (FDMA), Code Division Multiple Access (CDMA), Orthogonal Frequency Division Multiple Access (OFDMA), and any combination thereof. The public land mobile network includes a radio access network and a core network. Examples of the public land mobile network Include a 3GPP Universal Mobile Telecommunications System (UMTS), a 3GPP Evolved Packet System (EPS), a 3GPP2 CDMA2000 system, a Global System for Mobile communications (GSM (Registered Trademark))/General packet radio service (GPRS) system, a WiMAX system, and a mobile WiMAX system. The EPS includes a Long Term Evolution (LTE) system and an LTE-Advanced system.

### CITATION LIST

### Patent Literature

[Patent Literature 1] International Patent Publication No. WO 2014/050886

### Non-Patent Literature

[Non-Patent Literature 1] 3GPP TS 23.303 V12.3.0 (2014-12), “3rd Generation Partnership Project; Technical Specification Group Services and System Aspects: Proximity-based services (ProSe); Stage 2 (Release 12)”, December, 2014
[Non-Patent Literature 2] 3GPP TS 36.300 V12.4.0 (2014-12), “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 12)”, December, 2014

### SUMMARY OF INVENTION

### Technical Problem

3GPP Release 12 does not specific ally describe a procedure for starting sidelink communication in the partial coverage (i.e., sidelink communication between the relay UE and the remote UE). Further, 3GPP Release 12 does not provide details about determination of radio parameters (e.g., radio resources) to be used in the sidelink communication in the partial coverage.

Meanwhile, Patent Literature 1 describes the sidelink communication in the partial coverage. Specifically, in one example, a UE (i.e., remote UE candidate) requests a network to prepare direct discovery when the reception quality from the base station decreases. In response to this request from the UE, the network determines a relay UE and requests the determined relay UE to start the direct discovery operation. In accordance with the request from the network, the relay UE starts announcement (transmission) of a discovery signal for direct discovery or monitoring (reception) of a discovery signal transmitted from the remote UE.

Patent Literature 1 further describes that radio resources to be used for direct discovery and direct communication between the relay UE and the remote UE may be selected either by one of the UEs or by the base station.

However, in order to use radio resources dynamically selected by the base station or by one of the UEs for the sidelink communication in the partial coverage the relay UE and the remote UE need to know in advance these radio resources. However, when radio resources for the sidelink communication in the partial coverage are dynamically determined by the base station or the relay UE, it may be difficult for the remote UE which is, or is about to be, out of coverage to be securely informed about these radio resources. On the other hand, when radio resources for the sidelink communication in the partial coverage are dynamically determined by the remote UE as well, it may be difficult for the remote UE which is, or is about to be, out of coverage to securely notify the relay UE or the base station of these radio resources.

If the remote UE and the relay UE do not share the information on the radio resources to be used for the sidelink communication in the partial coverage, the remote UE and the relay UE are forced to monitor (receive) or announce signals for discovery in a lot of frequency resources or time resources.

One of the objects to be attained by embodiments disclosed herein is to provide an apparatus, a method, and a program that contribute to improvement of the sidelink communication in the partial coverage.

### Solution to Problem

In a first aspect, a radio terminal apparatus includes at least one radio transceiver, and at least one processor coupled to the at least one radio transceiver. The at least one processor is configured to, in response to receiving a request from a network when the radio terminal apparatus can connect to the network, perform sidelink communication with a second radio terminal, which is in a state of being unable to connect to the network, in accordance with a pre-configured first radio parameter using the at least one radio transceiver. The sidelink communication includes at least one of direct discovery and direct communication.

In a second aspect, a radio terminal apparatus includes at least one radio transceiver, and at least one processor coupled to the at least one radio transceiver. The at least one processor is configured to, when the radio terminal apparatus cannot connect to a network, perform sidelink communication with a first radio terminal, which is in a state of being able to connect to the network, In accordance with a pre-configured first radio parameter using the at least one radio transceiver. The sidelink communication includes at least one of direct discovery and direct communication.

In a third aspect, a control apparatus includes a memory, and at least one processor coupled to the memory. The at least one processor is configured to request a first radio terminal, which is in a state of being able to connect to a network, to start sidelink communication with a second radio terminal, which is in a state of being unable to connect to the network, in accordance with a pre-configured first radio parameter. The sidelink communication includes at least one of direct discovery and direct communication.

In a fourth aspect, a method performed by a first radio terminal includes, in response to receiving a request from a network when the first radio terminal can connect to the network, performing sidelink communication with a second radio terminal, which is in a state of being unable to connect to the network, in accordance with a pre-configured first radio parameter. The sidelink communication includes at least one of direct discovery and direct communication.

In a fifth aspect, a method performed by a second radio terminal includes, when the second radio terminal cannot connect to a network, performing sidelink communication with a first radio terminal, which is in a state of being able to connect to the network, in accordance with a pre-configured first radio parameter. The sidelink communication includes at least one of direct discovery and direct communication.

In a sixth aspect, a method performed by a control apparatus includes requesting a first radio terminal, which is In a state of being able to connect to a network, to start sidelink communication with a second radio terminal, which is in a state of being unable to connect to the network, in accordance with a pre-configured first radio parameter. The sidelink communication includes at least one of direct discovery and direct communication.

In a seventh aspect, a program includes instructions (software codes) that, when loaded into a computer, cause the computer to perform the method according to the aforementioned fourth, fifth, or sixth aspect.

### Advantageous Effects of Invention

According to the aforementioned aspects, it is possible to provide an apparatus, a method, and a program that contribute to improvement of the sidelink communication in the partial coverage.

### BRIEF DESCRIPTION OF DRAWINGS

FIG. 1 is a diagram showing a configuration example of a public land mobile network according to several embodiments;

FIG. 2 is a diagram showing a configuration example of the public land mobile network according to several embodiments;

FIG. 3 is a flowchart showing one example of operations of a relay UE according to a first embodiment;

FIG. 4 is a flowchart showing one example of operations of a remote UE according to the first embodiment;

FIG. 5 is a sequence diagram showing one example of a sidelink communication procedure according to the first embodiment;

FIG. 6 is a flowchart showing one example of operations of a relay UE according to a second embodiment;

FIG. 7 is a flowchart showing one exam pie of operations of a remote UE according to the second embodiment;

FIG. 8 is a sequence diagram showing one example of a sidelink communication procedure according to the second embodiment;

FIG. 9 is a flowchart showing one example of operations of a relay UE according to a third embodiment;

FIG. 10 is a block diagram showing a configuration example of a relay UE according to several embodiments; and

FIG. 11 is a block diagram showing a configuration example of a control apparatus (e.g., ProSe function entity) according to several embodiments.

### DESCRIPTION OF EMBODIMENTS

Specific embodiments are explained hereinafter in detail with reference to the drawings. In the drawings, the same or corresponding elements are denoted by the same reference signs, and repetitive descriptions will be avoided as necessary for clarity of explanation.

Embodiments described below will be explained mainly using specific examples with regard to an Evolved Packet System (EPS), However, these embodiments are not limited to being applied to the EPS and may also be applied to other mobile communication networks or systems such as a 3GPP (UMTS), a 3GPP2 CDMA2000 system, a GSM/GPRS system, and a WiMAX system.

### First Embodiment

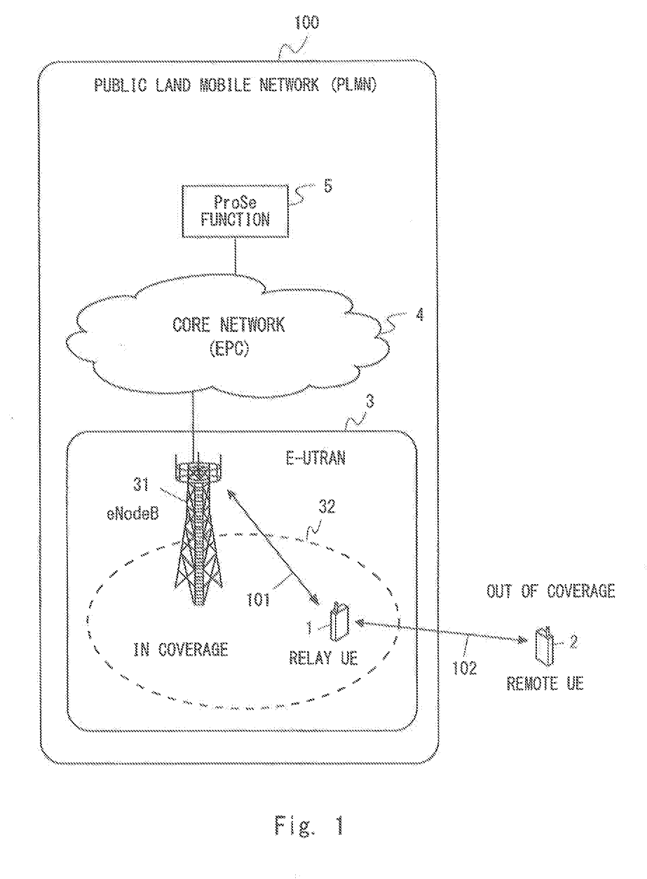

FIG. 1 shows a configuration example of a network according to this embodiment. Both a relay UE 1 and a remote UE 2 are radio . terminals capable of performing ProSe (i.e., ProSe-enabled UEs) and are able to perform sidelink communication on an inter-terminal direct Interface (i.e., PC5 interface or sidelink) 102, The sidelink communication includes at least one of ProSe Direct Discovery and ProSe Direct Communication, The sidelink communication is performed by using a radio communication technology (E-UTRA technology) that is also used to access a base station (eNodeB) 31.

The relay UE 1 relays traffic (downlink and uplink) between the remote UE 2 and a PLMN 100 (i.e., E-UTRAN 3 and EPC 4). In some implementations, the relay UE 1 attaches to the EPC 4, establishes a PDN connection to communicate with a ProSe function entity 5, and communicates with the ProSe function entity 5 to start sidelink communication. The relay UE 1 may use, for example, network-level discovery (i.e., EPC-level ProSe Discovery) provided by the ProSe function entity 5 or may receive, from the ProSe function entity 5, a message indicating permission for the relay UE 1 to activate direct discovery or direct communication. The relay UE 1 may further establish another PDN connection to communicate with a Packet Data Network (PDN) other than the ProSe function entity 5 and communicate with a node(s) in this PDN.

The remote UE 2 communicates with the ProSe function entity 5 or another PDN node via the direct interface (i.e., PC5 interface or sidelink) 102 with the relay UE 1. In the example shown in FIG. 1, the remote UE 2 is located out of a cell 32 of the eNodeB 31 (i.e., out of coverage). However, the remote UE 2 may be located within the cell 32 and be in a state of being unable to connect to the PLMN 100 due to any condition (e.g., selection by the user). The remote UE 2 performs the sidelink communication with the relay UE 1 when the remote UE 2 cannot connect to the PLMN 100 (e.g., out of coverage).

For convenience of explanation, in this specification, the sidelink communication between the relay UE 1 and the remote UE 2 is referred to as the “sidelink communication in the partial coverage”. However, the “sidelink communication in the partial coverage” herein includes sidelink communication between the relay UE 1 that is in coverage and the remote UE 2 performed when the remote UE 2 is unable to connect to the PLMN 100 due to various factors. In this specification, the “sidelink communication in the partial coverage” may also be referred to as “ProSe UE-to-Network Relaying”.

It may be determined that the remote UE 2 cannot connect to the PLMN 100 when the reception quality (e.g., Reference Signal Received Power (RSRP) or Reference Signal Received Quality (RSRQ)) of a radio signal transmitted from one of the eNodeBs 31 in the PLMN 100 is equal to or smaller than a predetermined threshold value. In other words, the remote UE 2 may determine that it cannot connect to the PLMN 100 in response to detecting that it has not successfully received the radio signal from the PLMN 100. Alternatively, the remote UE 2 may determine that it cannot connect to the PLMN 100 based on detecting that a connection to the PLMN 100 (e.g., attach to the EPC 4) has been rejected although it can receive radio signals from the eNodeB 31, Alternatively, the remote UE 2 may determine that it cannot connect to the PLMN 100 based on detecting that the remote UE 2 cannot normally communicate with the ProSe function entity 5 while it has been allowed to connect to the PLMN 100, Alternatively, the remote UE 2 may determine that it cannot connect to the PLMN 100 based on detecting that it has forcibly disconnected or deactivated its connection to the PLMN 100 according to an instruction from the user or from a control node in the PLMN 100 (e.g., ProSe function entity 5 or Operation Administration and Maintenance (OAM) server).

The eNodeB 31 is an entity located in the radio access network (i.e., E-UTRAN) 3, manages the cell 32 and is able to perform communication (101) with the relay UE 1 (101) by using the E-UTRA technology.

The core network (i.e., EPC) 4 includes a plurality of user-plane entities (e.g., Serving Gateway (S-GW) and Packet Data Network Gateway (P-GW)) and a plurality of control-plane entities (e.g., Mobility Management Entity (MME) and Home Subscriber Server (HSS)). The user-plane entities relay user data of the relay UE 1 and the remote UE 2 between the E-UTRAN 3 and an external network (PDN), The control-plane entitles perform various kinds of control for the relay UE 1 including mobility management, session management (bearer management), subscriber information management, and billing management.

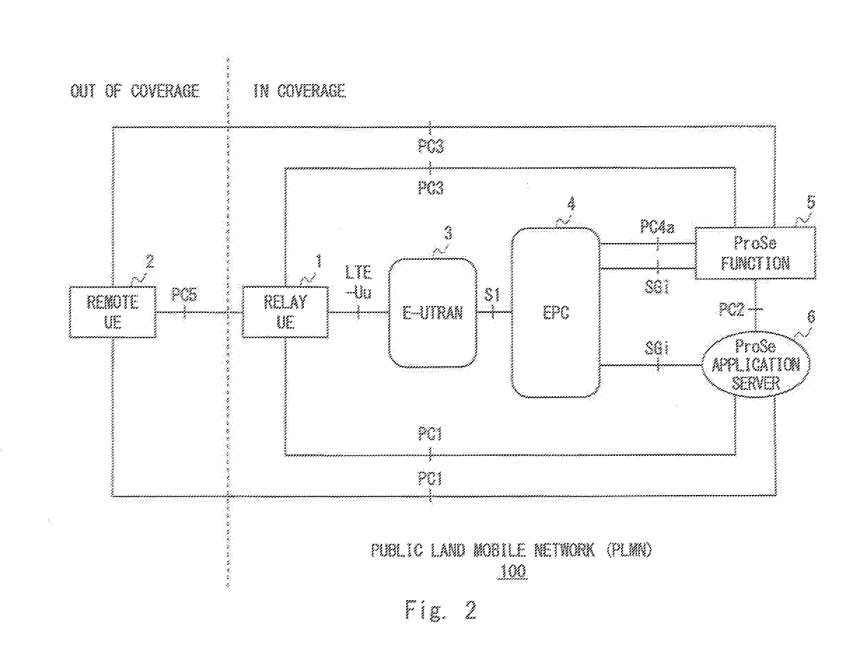

FIG. 2 shows reference points used in the sidelink communication in the partial coverage (ProSe UE-to-Network Relaying), Each reference point may be referred to as an “interface”. FIG. 2 shows a non-roaming architecture in which the relay UE 1 and the remote UE 2 use a subscription of the same PLMN 100. However, the Home PLMN (HPLMN) of the remote UE 2 may differ from the HPLMN of the relay UE 1. As one of the main applications of the sidelink communication in the partial coverage (ProSe UE-to-Network Relaying), a public safety usage is assumed. In the public safety usage, for example, the relay UE 1 in the PLMN 100 may perform sidelink communication with the remote UE 2 that does not have a subscription with the PLMN 100.

A PC1 reference point is a reference point between a ProSe application server 6 and a ProSe application in each of the relay UE 1 and the remote UE 2 and. The PC1 reference point is used to define application-level signalling requirements. The PC1 reference point depends on the user plane of the EFC 4 and, accordingly, communication between the ProSe application of the UE 1 and the ProSe application server 6 is transferred on the user plane of the EPC 4, Therefore, the ProSe application server 6 communicates with the EPC 4 (i.e., P-GW) through an SGi reference point.

A PC2 reference point is a reference point between the ProSe application server 6 and the ProSe function entity 5. The PC2 reference point is used to define interactions between the ProSe application server 6 and the ProSe functionality provided by the 3GPP EPS through the ProSe function entity 5.

A PC3 reference point is a reference point between each of the relay UE 1 and the remote UE 2 and the ProSe function entity 5. The PC3 reference point is used to define interactions between each HE relay UE 1 and remote UE 2) and the ProSe function entity 5 (e.g., UE registration, application registration, and authorization for ProSe Direct Discovery and EPC-level ProSe Discovery requests). The PC3 reference point depends on the user plane of the EPC 4 and, accordingly, ProSe control signalling between the UE 1 and the ProSe function entity 5 is transferred on the user plane of the EPC 4, Therefore, the ProSe function entity 5 communicates with the EPC 4 (i.e., P-GW) through an SGi reference point,

A PC4a reference point is a reference point between the ProSe function entity 5 and an HSS in the EPC 4, This reference point is used by the ProSe function entity 5, for example, to acquire subscriber information related to ProSe services.

As already described above, the PC5 reference point is a reference point between ProSe-enabled UEs and is used for the control plane and user plane of ProSe Direct Discovery, ProSe Direct Communication, and ProSe UE-to-Network Relay. The relay UE 1 and the remote UE 2 according to this embodiment perform sidelink communication including at least one of direct discovery and direct communication on the PC5 reference point.

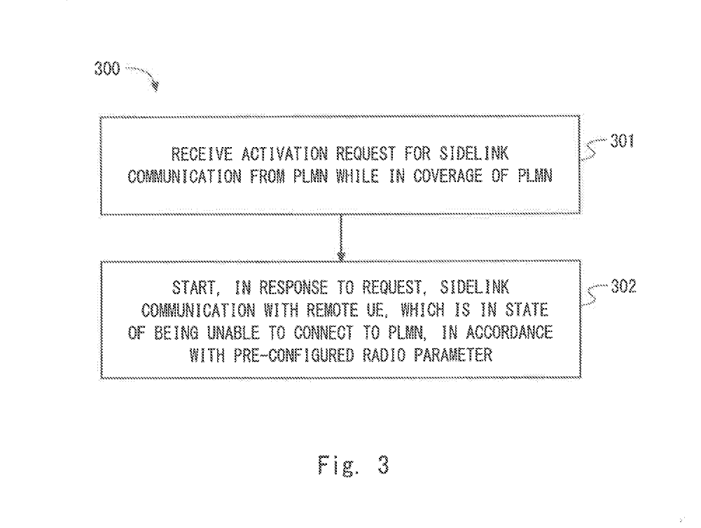

in the following description, the sidelink communication procedure in the partial coverage according to this embodiment will be described. FIG. 3 is a flowchart showing one example (Process 300) of operations of the relay UE 1 regarding the sidelink communication in the partial coverage. In Block 301, the relay UE 1 receives an activation request of sidelink communication from the PLMN 100 when the relay UE 1 is in a state of being able to connect to the PLMN 100 (e.g., in coverage of the PLMN 100). The state of being able to connect to the PLMN 100 includes, at least, a state in which the relay UE 1 is in coverage of the PLMN 100 (e.g., in the cell 32). In other words, the state in which the relay UE 1 is in coverage of the PLMN 100 (e.g., in the cell 32) may be a necessary condition or may be a necessary and sufficient condition for the relay UE 1 to be in the state of being able to connect to the PLMN 100. The state of being able to connect to the PLMN 100 may include, besides a state in which the relay UE 1 is in coverage (e.g., in the cell 32), a state in which the user does not restrict the relay UE 1 to connect to the PLMN 100. In the following description, it is assumed that the state of being able to connect to the PLMN 100 means that the relay UE 1 is in coverage of the PLMN 100.

As will be described later, this activation request may be transmitted from one of the eNodeB 31, an MME in the EPC 4, the ProSe function entity 5, and an Operation Administration and Maintenance (OAM) server coupled to the PLMN 100. In some implementations, this activation request may be transmitted when the network (e.g., eNodeB 31, MME, or ProSe function entity 5) detects that the remote UE 2 is, or is about to be, out of coverage. Further or alternatively, this activation request may be transmitted in response to reception by the PLMN 100 of a notification from the remote UE 2 (e.g., indicating that it is about to be out of coverage). Further or alternatively, this activation request may be transmitted when the control apparatus in the network (e.g., eNodeB 31, MME, ProSe function entity 5, or OAM server) detects that the network facility has gone down or is likely to go down.

In Block 302, in response to the reception of the activation request in Block 301, the relay UE 1 starts sidelink communication with the remote UE 2, which is in the state of being unable to connect to the PLMN 100, in accordance with a pre-configured parameters(s) (pre-configured radio parameter(s)). The pre-configured radio parameter(s) specifies, for example, at least one of: a frequency band identifier; a center frequency (E-UTRA Absolute Radio Frequency Channel Number (EARFCN)); maximum transmission power (P-MAX-ProSe); a Time Division Duplex (TDD) uplink-downlink configuration; and resource blocks (the number of resource blocks (Physical Resource Blocks (PRBs), an offset of Start PRB, and offset of End PRB). In some implementations, in order to perform direct discovery to search for the remote UE 2 which is in the state of being unable to connect to the PLMN 100, the relay UE 1 may perform announcement (transmission) or monitoring (reception) of a discovery message (a discovery signal) in accordance with the pre-configured radio parameter.

As with the relay UE 1, the remote UE 2 also starts the sidelink communication in the partial coverage in accordance with the pre-configured radio parameter(s), The pre-configured radio parameter(s) held by the relay UE 1 includes the same or corresponding configuration as that held by the remote UE 2.

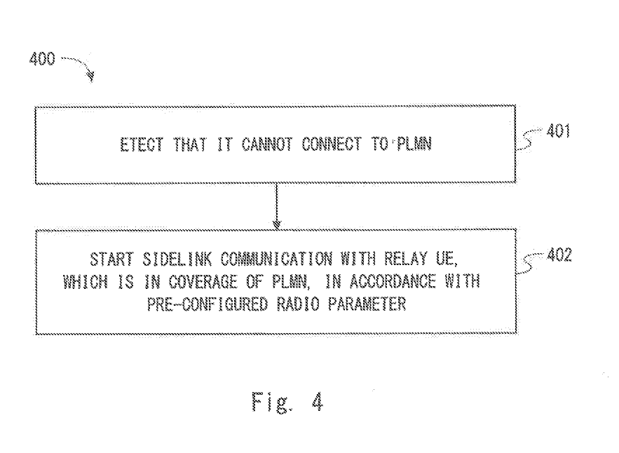

FIG. 4 is a flowchart showing one example (Process 400) of operations of the remote UE 2 regarding the sidelink communication in the partial coverage. In Block 400, the remote UE 2 detects that it cannot connect to the PLMN 100. For example, the remote UE 2 may determine that it is out of coverage of the PLMN 100 when the reception quality (e.g., RSRP or RSRQ) of the downlink signal from the eNodeB 31 is equal to or smaller than a predetermined threshold value. In Block 402, the remote UE 2 starts the sidelink communication with the relay UE 1, which is In coverage of the PLMN 100, in accordance with the pre-configured parameter (pre-configured radio parameter).

The “pre-configured radio parameter” described in this embodiment is stored in a built-in memory that is installed in the relay UE 1 (or the remote UE 2) or stored in a removable memory (e.g., Universal Integrated Circuit Card (UICC)) with which the relay UE 1 (or the remote UE 2) can communicate through an interface. The built-in memory or the removable memory is a volatile memory, a non-volatile memory, or a combination thereof. The volatile memory is, for example, a Static Random Access Memory (SRAM), a Dynamic RAM (DRAM), or a combination thereof. The non-volatile memory is, for example, a mask Read Only Memory (MROM), an Electrically Erasable Programmable ROM (EEPROM), a flash memory, a hard disc drive, or any combination thereof.

The UICC is a smart card used in a cellular communication system such as a GSM system, a UMTS, and an LTE system. The UICC includes a processor and a memory and executes a Subscriber Identity Module (SIM) application or a Universal Subscriber Identity Module (USIM) application for network authentication, in a strict sense, the UICC is different from the UIM, the SIM, and the USIM. However, these terms are often used synonymously. Accordingly, while the present application mainly employs the term UICC, the term UICC as used herein may mean the UIM, the SIM, the USIM or the like.

As described above with reference to FIGS. 3 and 4, both the relay UE 1 and the remote UE 2 are configured to perform the sidelink communication in the partial coverage in accordance with the same or corresponding pre-configured radio parameter(s). Thus, the relay UE 1 and the remote UE 2 can perform the sidelink communication in the partial coverage in a stable manner. For example, according to this embodiment, the procedure for sharing the information on the radio resources to be used for the sidelink communication in the partial coverage between the relay UE 1 and the remote UE 2 (e.g., sending a notification regarding the radio resources for the sidelink communication to the remote UE 2 from the eNodeB 31 or the relay UE 1) can be omitted.

Note that 3GPP Release 12 defines that when two UEs (e.g., the relay UE 1 and the remote UE 2) both cannot connect to the PLMN 100 (e.g., out of coverage), these UEs perform sidelink communication without assistance of the PLMN 100 (i.e., out of coverage ProSe Direct Communication) using the radio parameter(s) (e.g., Public Safety ProSe Carrier) that is pre-configured in a Mobile Equipment (ME) or In a UICC (e.g., see Non-Patent Literature 2). The “pre-configured radio parameter” for the sidelink communication in the partial coverage described in this embodiment may be common to the “pre-configured radio parameter” for the sidelink communication without the assistance of the PLMN 100. In other words, the “pre-configured radio parameter” for the sidelink communication in the partial coverage may also be used to perform the sidelink communication without the assistance of the PLMN 100 when both the relay UE 1 and the remote UE 2 cannot connect to the PLMN 100. In this way, it is possible to reduce the amount of data that is pre-configured in the relay UE 1 and the remote UE 2.

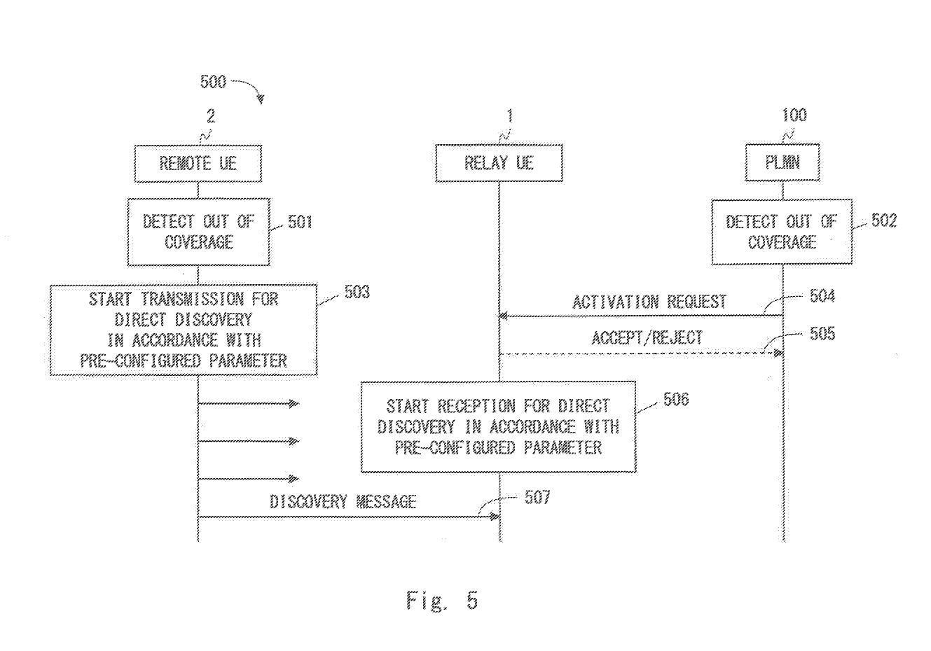

FIG. 5 is a sequence diagram showing one example (Process 500) of the sidelink communication procedure in the partial coverage according to this embodiment. In the example shown in FIG. 5, the relay UE 1 and the remote UE 2 perform direct discovery.

In Block 501, the remote UE 2 detects that it is, or is about to be, out of coverage of the PLMN 100. As already described above, the remote UE 2 may detect that it cannot, or likely cannot, connect to the PLMN 100.

In Block 502, the control apparatus in the PLMN 100 (e.g., eNodeB 31, MME, ProSe function entity 5, or OAM server) detects that the remote UE 2 is, or is about to be, out of coverage. As already described above, the PLMN 100 may detect that network facility (e.g., the network to which the remote UE 2 is connected, the base station (eNodeB), or the cell) has gone down or is likely to go down,

In Block 503, the remote UE 2 starts announcement (transmission) for direct discovery in accordance with the pre-configured parameter (the pre-configured radio parameter).

In Block 504, the control apparatus in the PLMN 100 (e.g., eNodeB 31, MME, ProSe function entity 5, or OAM server) may transmit an activation request to the relay UE 1. This activation request requests the relay UE 1 to start the sidelink communication in the partial coverage in accordance with the pre-configured (radio) parameter (pre-configured radio parameter).

In some implementations, the PLMN 100 may select, as the relay UE 1, a UE which is located at a cell edge of the cell to which the remote UE 2 was belonged or one of neighboring cells thereof. Alternatively, when a specific base station (eNodeB) or a cell is going down, the PLMN 100 may select, as the relay UE 1, a UE which is located in one of neighboring cells (in particular, located in a cell edge of one of the neighboring cells) of the base station or the cell that is going down. Alternatively, when the network (PLMN) of one operator goes down, a UE connecting to another PLMN (in this example, the PLMN 100) may be selected as the relay UE 1.

In Block 505, in response to the activation request transmitted in Block 504, the relay UE 1 sends to the PLMN 100 a message indicating whether the relay UE 1 can activate the sidelink communication in the partial coverage. The relay UE 1 may reject the activation request, for example, when its battery is low of charge or its load level is high. The transmission of the response message in Block 505 may be omitted.

In Block 506, in response to the activation request transmitted in Block 504, the relay UE 1 starts the reception operation for direct discovery in accordance with the pre-configured radio parameter(s). In Block 507, the relay UE 1 receives a discovery message transmitted from the remote UE 2.

The example shown in FIG. 5 is merely one example. For example, the relay UE 1 may transmit a discovery message for direct discovery and the remote UE 2 may receive the discovery message. Further, in place of the direct discovery or after the direct discovery, direct communication may be performed. Except for the use of the pre-configured radio parameter(s), the sidelink communication in the partial coverage by the relay UE 1 and the remote UE 2 may be performed in accordance with the same procedure as the sidelink communication while out-of-coverage or in-coverage.

### Second Embodiment

This embodiment provides a modified example of the sidelink communication procedure described in the first embodiment. The configuration example of a public land mobile network according to this embodiment is the same as that shown in FIGS. 1 and 2, In this embodiment, the relay UE 1 and the remote UE 2 start the sidelink communication in accordance with a radio parameter(s) specified by the eNodeB 31 after starting the sidelink communication in the partial coverage in accordance with the pre-configured radio parameter(s).

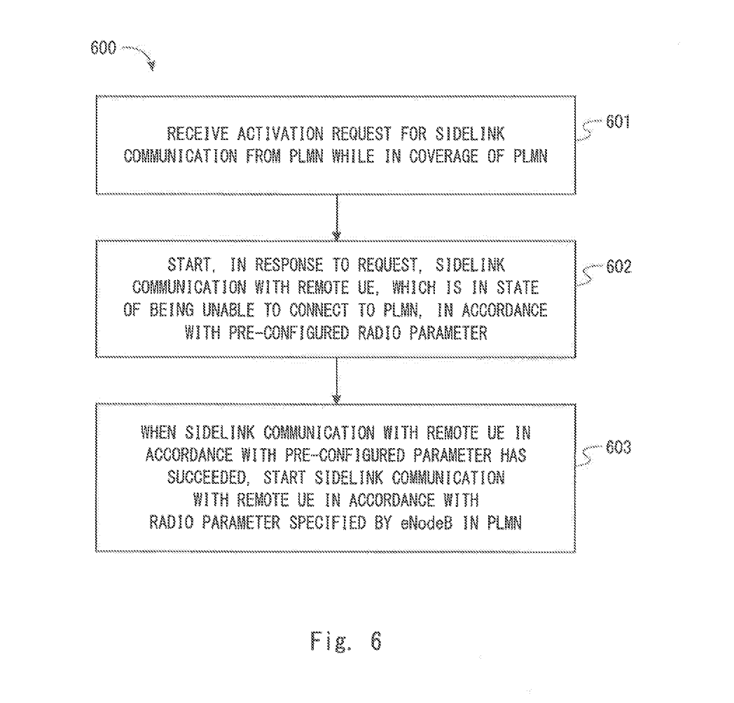

FIG. 6 is a flowchart showing one example (Process 600) of operations of the relay UE 1 regarding the sidelink communication in the partial coverage. The processes in Blocks 601 and 602 are similar to the processes in Blocks 301 and 302 in FIG. 3. In Block 603, when the sidelink communication (e.g., direct discovery) with the remote UE 2 in accordance with the pre-configured parameter(s) (pre-configured radio parameter(s)) has succeeded, the relay UE 1 starts the sidelink communication (e.g., direct communication) with the remote UE 2 in accordance with a radio parameter(s) that is specified by the eNodeB 31 in the PLMN 100.

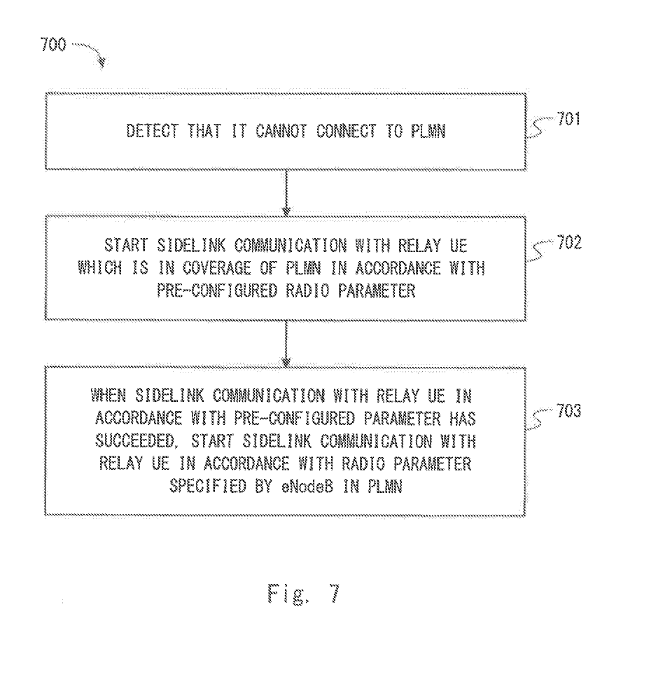

FIG. 7 is a flowchart showing one example (Process 700) of operations of the remote UE 2 regarding the sidelink communication in the partial coverage. The processes in Blocks 701 and 702 are similar to the processes in Blocks 401 and 402 shown in FIG. 4. In Block 703, when the sidelink communication (e.g., direct discovery) with the relay UE 1 in accordance with the pre-configured parameter(s) (pre-configured radio parameter(s)) has succeeded, the remote UE 2 starts the sidelink communication (e.g., direct communication) with the relay UE 1 in accordance with a radio parameter(s) that is specified by the eNodeB 31 in the PLMN 100.

The remote UE 2 may receive, from the relay UE 1, the radio parameter specified by the eNodeB 31. The relay UE 1 may transmit the radio parameter specified by the eNodeB 31 to the remote UE 2 through a control channel of the direct interface 102 (i.e., sidelink or PC5 interface) such as a Physical sidelink broadcast channel (PSBCH) or a Physical sidelink control channel (PSCCH). The PSBCH transmits a control logical channel for ProSe (i.e., Sidelink Broadcast Control Channel (SBCCH)). The SBCCH includes system information and synchronization information. The relay UE 1 derives the content of SBCCH from the radio parameter (e.g., radio resource configuration) received from the eNodeB 31 while in-coverage (the cell 32). When the remote UE 2 is out of coverage, it selects the relay UE 1 as a synchronization reference and uses the content of SBCCH received from the relay UE 1.

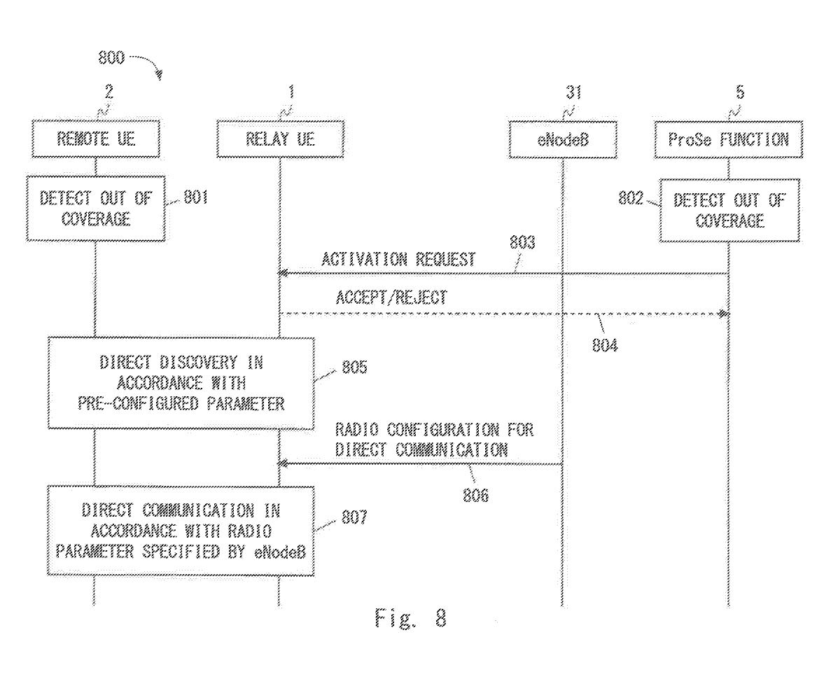

FIG. 8 is a sequence diagram showing one example (Process 800) of the sidelink communication procedure in the partial coverage according to this embodiment. In the example shown in FIG. 8, the relay UE 1 and the remote UE 2 perform direct discovery in accordance with the pre-configured parameter(s) (pre-configured radio parameter) and then performs direct communication in accordance with the radio parameter(s) specified by the eNodeB 31 after the direct discovery has succeeded.

The processes in Blocks 801 to 805 are similar to the processes in Blocks 501 to 507 shown in FIG. 5. As described above with reference to FIG. 5, in Block 805, the relay UE 1 may announce (transmit) a discovery message (discovery signal) or instead the remote UE 2 may announce it.

In Block 806, the relay UE 1 receives the radio configuration for direct communication from the eNodeB 31, The radio configuration for direct communication specifies radio resources to lie used for direct communication (e.g., frequency resources, time resources, resource blocks, transmission power, or any combination thereof). In one implementation, the eNodeB 31 may transmit a resource pool(s) for the Autonomous resource selection via System Information Block (SIB) 18. In this case, the relay UE 1 may autonomously select resources for sidelink control and data from the resource pool(s) specified by SIB 18.

Alternatively, the relay UE 1 may request the eNodeB 31 for the radio configuration prior to the reception of the radio configuration for direct communication. For example, the relay UE 1 may transmit, to the eNodeB 31, a ProSe Direct indication indicating that it has an interest in ProSe Direct Communication. In response to the ProSe Direct indication, the eNodeB 31 may allocate to the relay UE 1, via dedicated RRC signalling, a resource pool(s) for the Autonomous resource selection of ProSe Direct Communication.

Alternatively, the Scheduled resource allocation may be used for ProSe Direct Communication in the partial coverage. Specifically, the relay UE 1 may transmit to the eNodeB 31 a scheduling request together with a ProSe Buffer Status Report (BSR). In response to this scheduling request, the eNodeB 31 may schedule resources for sidelink control and data to the relay UE 1 in accordance with the Scheduled resource allocation of ProSe Direct Communication.

In Block 807, the relay UE 1 and the remote UE 2 perform direct communication in accordance with the radio parameter specified by the eNodeB 31. As already described above, the relay UE 1 may transmit the radio parameter specified by the eNodeB 31 in a PSBCH to provide it to the remote UE 2.

The procedure shown in FIG. 8 describes the example in which the direct discovery procedure is performed in accordance with the pre-configured radio parameter and then direct communication is performed in accordance with the radio parameter specified by the eNodeB 31. The procedure shown in FIG. 8 is one of the specific examples of the procedure for starting the sidelink communication in accordance with the radio parameter specified by the eNodeB 31 after starting the sidelink communication in the partial coverage in accordance with the pre-configured radio parameter. This procedure may be modified as follows.

For example, the relay UE 1 may transmit, on the sidelink in accordance with the pre-configured radio parameter, a broadcast channel (PSBCH) indicating the radio parameter specified by the eNodeB 31. In this case, the remote UE 2 may receive the PSBCH from the relay UE 1 in accordance with the pre-configured radio parameter, then acquire the radio parameter specified by the eNodeB 31 from the received PSBCH, and after that transmit or receive a discovery signal for direct discovery in accordance with the radio parameter specified by the eNodeB 31.

Alternatively, the relay UE 1 may perform direct discovery in accordance with the pre-configured radio parameter, further start direct communication with the remote UE 2 in accordance with the pre-configured radio parameter, and then change radio resources used for this direct communication to the radio resources specified by the eNodeB 31.

Further, the switch from the pre-configured radio parameter to the radio parameter specified by the eNodeB 31 may be performed in accordance with an instruction from the eNodeB 31 or another network node. Alternatively, this switch may be performed autonomously by the relay UE 1 and the remote UE 2 after a predetermined time period has passed since the start of the sidelink communication with the pre-configured radio parameter.

As will be understood from the aforementioned description, in this embodiment, the relay UE 1 and the remote UE 2 are configured to start the sidelink communication in the partial coverage in accordance with the pre-configured radio parameter and then start the sidelink communication in accordance with the radio parameter specified by the eNodeB 31. In this way, it is possible to reduce interference to other sidelink communication between other UEs that use the pre-configured radio parameter.

### Third Embodiment

This embodiment provides a modified example of the sidelink communication procedure described in the first and second embodiments. The configuration example of a public land mobile network according to this embodiment is the same as that shown in FIGS. 1 and 2.

Similar to the first and second embodiments, the relay UE 1 according to this embodiment is configured to receive a activation request for the sidelink communication from the PLMN 100 when it is in coverage of the PLMN 100 (e.g., in the cell 32). In this embodiment, however, this activation request includes an indication indicating which of the pre-configured radio parameter in the relay UE 1 and the remote UE 2 (hereinafter referred to as a first radio parameter) and the radio parameter specified by the eNodeB 31 (hereinafter referred to as a second radio parameter) should be used for the sidelink communication in the partial coverage (i.e., the sidelink communication with the remote UE 2 which is out of coverage). The relay UE 1 is configured to choose, in accordance with this indication, one of the first and second radio parameters to use for the sidelink communication in the partial coverage.

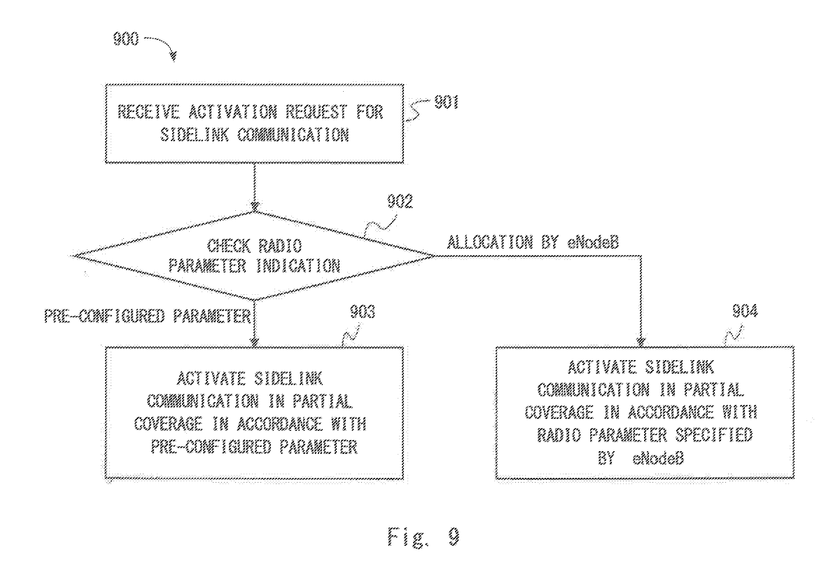

FIG. 9 is a flowchart showing one example (Process 900) of operations of the relay UE 1 according to this embodiment. In Block 901, the relay UE 1 receives the activation request for the sidelink communication from the PLMN 100 when it is in coverage of the PLMN 100 (e.g., in the cell 32). As described above, this activation request includes the indication indicating which of the first and second radio parameters should be used for the sidelink communication in the partial coverage.

In Block 902, the relay UE 1 checks the radio parameter indication contained In the activation request and chooses one of the first and second radio parameters. When the first radio parameter (i.e., the pre-configured radio parameter in the relay UE 1 and the remote UE 2) should be used, the relay UE 1 activates the sidelink communication In the partial coverage in accordance with the pre-configured parameter (first radio parameter) (Block 903). On the other hand, when the second radio parameter (i.e., the radio parameter specified by the eNodeB 31) should be used, the relay UE 1 activates the sidelink communication in the partial coverage in accordance with the radio parameter specified by the eNodeB 31 (Block 904).

In the method described in this embodiment, the relay UE 1 can change the procedure for starting the sidelink communication in the partial coverage according to the Instruction from the network (the PLMN 100), For example, the network (the PLMN 100) may determine which of the first and second radio parameters the relay UE 1 should use depending on the state of the remote UE 2 (e.g., depending on whether the remote UE 2 holds the radio parameter specified by the eNodeB 31).

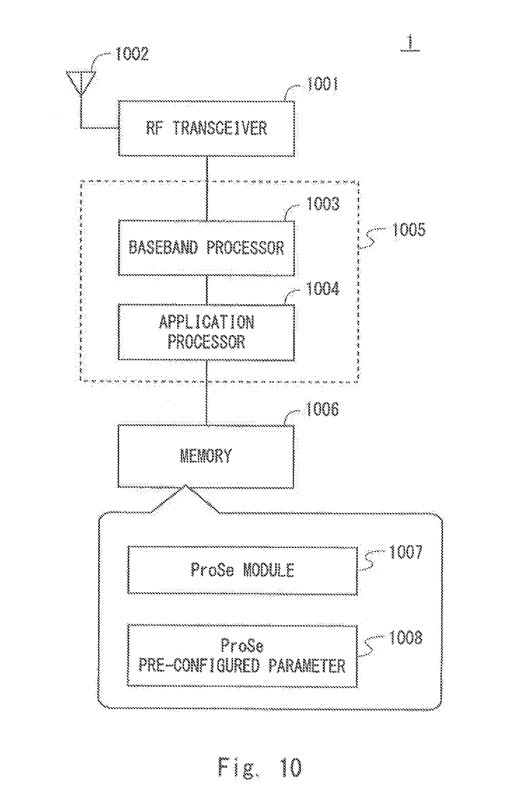

Lastly, configuration examples of the relay UE 1, the remote UE 2, and the control apparatus in the network (e.g., eNodeB 31, MME, ProSe function entity 5, or OAM server) according to the aforementioned embodiments will be described. FIG. 10 is a block diagram showing a configuration example of the relay UE 1. The remote UE 2 may have a configuration similar to that shown in FIG. 10. A Radio Frequency (RF) transceiver 1001 performs analog RF signal processing to communicate with the eNodeB 31 in the PLMN 100. The RF transceiver 1001 may further be used for ProSe Direct Discovery and direct communication between the UEs 1. The RF transceiver 1001 may include a first transceiver used for communication with the eNodeB 31 in the PLMN 100 and a second transceiver used for ProSe Direct Discovery and direct communication with another UE (e.g., remote UE 2). The analog RF signal processing performed by the RF transceiver 1001 includes frequency up-conversion, frequency down-conversion, and amplification. The RF transceiver 1001 is coupled to an antenna 1002 and a baseband processor 1003. That is, the RF transceiver 1001 receives modulated symbol data (or OFDM symbol data) from the baseband processor 1003, generates a transmission RF signal, and supplies the transmission RF signal to the antenna 1002. Further, the RF transceiver 1001 generates a baseband reception signal based on a reception RF signal received by the antenna 1002, and supplies the baseband reception signal to the baseband processor 1003.

The baseband processor 1003 performs digital baseband signal processing (i.e., data plane processing) and control plane processing for radio communication. The digital baseband signal processing includes (a) data compression/decompression, (b) data segmentation/concatenation, (c) composition/decomposition of a transmission format (i.e., transmission frame), (d) channel coding/decoding, (e) modulation (i.e., symbol mapping)/demodulation, (f) spreading/de-spreading, and (g) generation of OFDM symbol data (i.e., baseband OFDM signal) by Inverse Fast Fourier Transform (IFFT). On the other hand, the control plane processing Includes communication management of layer 1 (e.g., transmission power control), layer 2 (e.g., radio resource management and hybrid automatic repeat request (HARQ) processing), and layer 3 (e.g., signalling regarding attach, mobility, and call management).

The baseband processor 1003 may include a modem processor (e.g., a Digital Signal Processor (DSP)) that performs the digital baseband signal processing and a protocol stack processor (e.g., a Central Processing Unit (CPU) or a Micro Processing Unit (MPU)) that performs the control plane processing. In this case, the protocol stack processor, which performs control plane processing, may be integrated with an application processor 1004 described in the following.

The application processor 1004 is also referred to as a CPU, an MPU, a microprocessor, or a processor core. The application processor 1004 may include a plurality of processors (processor cores). The application processor 1004 loads a system software program (Operating System (OS)) and various application programs (e.g., a voice call application, a WEB browser, a mailer, a camera operation application, and a music player application) from a memory 1006 or from another memory (not shown) and executes these programs, thereby providing various functions of the UE1.

In some Implementations, as represented by a dashed line (1005) in FIG. 10, the baseband processor 1003 and the application processor 1004 may be integrated on a single chip. In other words, the baseband processor 1003 and the application processor 1004 may be implemented in a single System on Chip (SoC) device 1005. A SoC device may be referred to as a system Large Scale Integration (LSI) or a chipset.

The memory 1006 is a volatile memory, a non-volatile memory, or a combination thereof. The memory 1006 may include a plurality of memory devices that are physically independent from each other. The volatile memory is, for example, an SRAM, a DRAM, or a combination thereof. The non-volatile memory is, for example, an MROM, a PROM, a flash memory, a hard disc drive, or any combination thereof. The memory 1006 may include, for example, an external memory device that can be accessed from the baseband processor 1003, the application processor 1004, and the SoC 1005. The memory 1006 may include an internal memory device that is integrated in the baseband processor 1003, the application processor 1004, or the SoC 1005. Further, the memory 1006 may include a memory in a UICC.

The memory 1006 stores a ProSe module 1007 and a pre-configured parameter(s) (pre-configured radio parameter(s)) 1008. The radio parameter 1008 shown in FIG. 10 corresponds to the “pre-configured radio parameter(s)” in the relay UE 1 described in the aforementioned embodiment. As already described above, the memory 1006 may include a plurality of memory devices that are physically independent from each other, and these software and data may be stored in the same memory device or may be stored in different memory devices.

The ProSe module 1007 includes a software module to be executed by the baseband processor 1003 or the application processor 1004. Accordingly, the baseband processor 1003 or the application processor 1004 communicates with the ProSe function entity 5, the MME, and the eNodeB 31 to perform ProSe communication (e.g., EPC-level ProSe Discovery, ProSe Direct Discovery, ProSe Direct Communication) assisted by the PLMN 100 within the coverage of the PLMN 100 and to also perform registration procedures required for this ProSe communication.

The ProSe module 1007 further includes instructions and data to perform the processing of the relay UE 1 regarding the sidelink communication in the partial coverage described in the aforementioned embodiments. Thus, the baseband processor 1003 or the application processor 1004 loads software modules including the ProSe module 1007 from the memory 1006 and executes these loaded software modules, thereby performing the processing of the relay UE 1 described in the aforementioned embodiments.

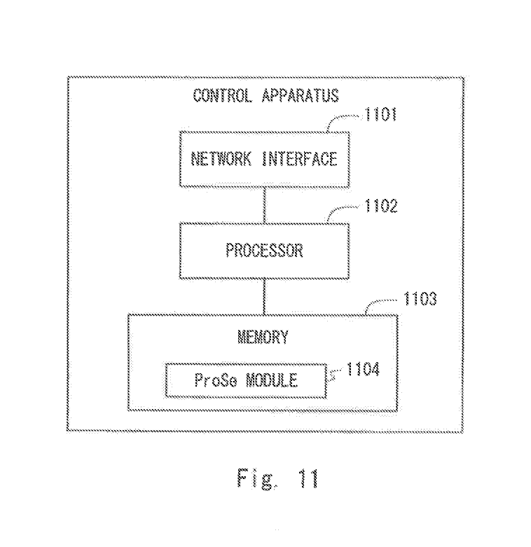

FIG. 11 shows a configuration example of the control apparatus in the network (e.g., eNodeB 31, MME, ProSe function entity 5, or OAM server). Referring to FIG. 11, this control apparatus includes a network inter face 1101, a processor 1102, and a memory 1103, The network interface 1101 is used to communicate with the relay UE 1. The network interface 1101 may include, for example, a network interface card (NIC) conforming to the IEEE 802.3 series.

The processor 1102 loads software (computer program) from the memory 1103 and executes the loaded software, thereby performing the processing of the control apparatus in the PLMN 100 described with reference to the sequence diagrams and flowchart in the aforementioned embodiments (e.g., transmission of the request for activation of the sidelink communication in the partial coverage). The processor 1102 may be, for example, a microprocessor, an MPU, or a CPU, The processor 1102 may include a plurality of processors,

The memory 1103 is composed of a combination of a volatile memory and a non-volatile memory. The memory 1103 may include a storage that is located apart from the processor 1102. In this case, the processor 1102 may access the memory 1103 via an I/O interface (not shown).

In the example shown in FIG. 11, the memory 1103 is used to store software modules including a ProSe module 1104. The ProSe module 1104 includes instructions and data for performing the processing of the control apparatus described in the aforementioned embodiments (e.g., transmission of the request for activation of the sidelink communication in the partial coverage). The processor 1102 loads software modules including the ProSe module 1104 from the memory 1103 and executes these loaded software modules, thereby performing the processing of the control apparatus described in the aforementioned embodiments.

As described above with reference to FIGS. 10 and 11, each of the processors included in the relay UE 1, the remote UE 2, and the control apparatus in the PLMN 100 according to the aforementioned embodiments executes one or more programs including instructions to cause a computer to perform an algorithm described with reference to the drawings. The program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### Other Embodiments

Each of the above-described embodiments may be used individually, or two or more of the embodiments may be appropriately combined with one another.

In the aforementioned embodiments, the relay UE 1 may notify the eNodeB 31 of the pre-configured radio parameter to be used for the sidelink communication in the partial coverage, or the radio resources (e.g., frequency resources) to be used for the sidelink communication in the partial coverage determined in accordance therewith. Accordingly, the eNodeB 31 is able to consider the radio resources to be used for the sidelink communication in the partial coverage at the time of scheduling of the uplink communication (101) with the relay UE 1 or uplink communication with another UE (radio resource allocation). The relay UE 1 may notify another node (e.g., the ProSe function entity 5 or the OAM server) of the pre-configured radio parameter to be used for the sidelink communication in the partial coverage, or the radio resources (e.g., frequency resources) to be used for the sidelink communication in the partial coverage determined in accordance therewith.

In the aforementioned embodiments, the example in which the specification of the second radio parameter for the sidelink communication and the notification sent to the relay UE 1 are performed by the eNodeB 31 has been described. However, the specification of the second radio parameter and the notification sent to the relay UE 1 may be performed by another node (e.g., the ProSe function entity 5 or the OAM server).

Use above-described embodiments are described by using specific examples mainly related to the EPS, However, these embodiments may be applied to other mobile communication systems such as a Universal Mobile Telecommunications System (UMTS), a 3GPP2 CDMA2000 system (1×RTT, High Rate Packet Data (HRPD)), a Global System for Mobile communications (GSM)/General packet radio service (GPRS) system, and a mobile WiMAX system, in this case, the processes or the procedures regarding sidelink communication performed by the eNodeB 31 described in the above-described embodiments may be performed by a radio access network node having a radio resource management function (e.g., Radio Network Controller (RNC) in a UMTS or Base Station Controller (BSC) in a GSM system).

Further, the embodiments stated above are merely examples of applications of the technical ideas obtained by the present inventors. Needless to say, these technical ideas are not limited to the above-described embodiments and various modifications can be made thereto.

For example, the whole or part of the embodiments disclosed above can be described as, but not limited to, the following supplementary notes.

### (Supplementary Note 1)

A radio terminal apparatus comprising:

at least one radio transceiver; and

at least one processor coupled to the at least one radio transceiver, wherein

the at least one processor is configured to, in response to receiving a request from a network when the radio terminal apparatus can connect to the network, perform sidelink communication with a second radio terminal, which is in a state of being unable to connect to the network, in accordance with a pre-configured first radio parameter using the at least one radio transceiver, and

the sidelink communication comprises at least one of direct discovery and direct communication.

### (Supplementary Note 2)

The radio terminal apparatus according to Supplementary Note 1, wherein the first radio parameter is also used to perform the sidelink communication without assistance of the network when both the radio terminal apparatus and the second radio terminal cannot connect to the network.

### (Supplementary Note 3)

The radio terminal apparatus according to Supplementary Note 1 or 2, wherein the first radio parameter is pre-configured in the radio terminal apparatus or in a Universal Integrated Circuit Card (UICC) coupled to the radio terminal apparatus.

### (Supplementary Note 4)

The radio terminal apparatus according to any one of Supplementary Notes 1 to 3, wherein the at least one processor is configured to start the sidelink communication with the second radio terminal in accordance with a second radio parameter specified by the network when the sidelink communication with the second radio terminal in accordance with the first radio parameter has succeeded.

### (Supplementary Note 5)

The radio terminal apparatus according to any one of Supplementary Notes 1 to 3, wherein the at least one processor is configured to start direct communication with the second radio terminal in accordance with a second radio parameter specified by the network when direct discovery with the second radio terminal in accordance with the first radio parameter has succeeded.

### (Supplementary Note 6)

The radio terminal apparatus according to any one of Supplementary Notes 1 to 5, wherein the at least one processor is configured to notify the network of the first radio parameter or a frequency resource to be used for the sidelink communication determined based on the first radio parameter.

### (Supplementary Note 7)

The radio terminal apparatus according to any one of Supplementary Notes 1 to 6, wherein the at least one processor is configured to send to the network, in response to the request, a message indicating whether the radio terminal apparatus can activate the sidelink communication.

### (Supplementary Note 8)

The radio terminal apparatus according to any one of Supplementary Notes 1 to 7, wherein the request comprises an indication indicating which of the first radio parameter and a second radio parameter specified by the network should be used for the sidelink communication with the second radio terminal.

### (Supplementary Note 9)

The radio terminal apparatus according to Supplementary Note 8, wherein the at least one processor is configured to choose, in accordance with the Indication, one of the first and second radio parameters to use for the sidelink communication.

### (Supplementary Note 10)

The radio terminal apparatus according to any one of Supplementary Notes 1 to 9, wherein the request is transmitted to the radio terminal apparatus from one of a base station in the network, a mobility management node in the network, an Operation Administration and Maintenance (OAM) server, and a control entity that controls network-assisted proximity-based service communication.

### (Supplementary Note 11)

A radio terminal apparatus comprising:

at least one radio transceiver; and

at least one processor coupled to the at least one radio transceiver, wherein

the at least one processor is configured to, when the radio terminal apparatus cannot connect to a network, perform sidelink communication with a first radio terminal, which is in a state of being able to connect to the network, in accordance with a pre-configured first radio parameter using the at least one radio transceiver, and

the sidelink communication comprises at least one of direct discovery and direct communication.

### (Supplementary Note 12)

The radio terminal apparatus according to Supplementary Note 11, wherein the first radio parameter is also used to perform the sidelink communication without assistance of the network when both the radio terminal apparatus and the first radio terminal cannot connect to the network.

### (Supplementary Note 13)

The radio terminal apparatus according to Supplementary Note 11 or 12, wherein the first radio parameter is pre-configured in the radio terminal apparatus or in a Universal Integrated Circuit Card (UICC) coupled to the radio terminal apparatus.

### (Supplementary Note 14)

The radio terminal apparatus according to any one of Supplementary Notes 11 to 13, wherein the at least one processor is configured to start the sidelink communication with the first radio terminal in accordance with a second radio parameter specified by the network when the sidelink communication with the first radio terminal in accordance with the first radio parameter has succeeded.

### (Supplementary Note 15)

The radio terminal apparatus according to any one of Supplementary Notes 11 to 13, wherein the at least one processor is configured to start direct communication with the first radio terminal in accordance with a second radio parameter specified by the network when direct discovery with the first radio terminal in accordance with the first radio parameter has succeeded.

### (Supplementary Note 16)

A control apparatus comprising:

a memory; and

at least one processor coupled to the memory, wherein

the at least one processor is configured to request a first radio terminal, which is in a state of being able to connect to a network, to start sidelink communication with a second radio terminal, which is in a state of being unable to connect to the network, in accordance with a pre-configured first radio parameter, and

the sidelink communication comprises at least one of direct discovery and direct communication.

### (Supplementary Note 17)

The control apparatus according to Supplementary Note 16, wherein the first radio parameter is also used to perform the sidelink communication without assistance of the network when both the first radio terminal and the second radio terminal cannot connect to the network.

### (Supplementary Note 18)

The control apparatus according to Supplementary Note 16 or 17, wherein the first radio parameter is pre-configured in the first radio terminal or in a Universal integrated Circuit Card (UICC) coupled to the first radio terminal.

### (Supplementary Note 19)

A method performed by a first radio terminal, the method comprising, in response to receiving a request from a network when the first radio terminal can connect to the network, performing sidelink communication with a second radio terminal, which is in a state of being unable to connect to the network, in accordance with a pre-configured first radio parameter, wherein the sidelink communication comprises at least one of direct discovery and direct communication.

### (Supplementary Note 20)

The method according to Supplementary Note 19, wherein the first radio parameter is also used to perform the sidelink communication without assistance of the network when both the first radio terminal and the second radio terminal cannot connect to the network.

### (Supplementary Note 21)

The method according to Supplementary Note 19 or 20, wherein the first radio parameter is pre-configured in the first radio terminal or in a Universal Integrated Circuit Card (UICC) coupled to the first radio terminal.

### (Supplementary Note 22)

The method according to any one of Supplementary Notes 19 to 21, further comprising starting the sidelink communication with the second radio terminal in accordance with a second radio parameter specified by the network when the sidelink communication with the second radio terminal In accordance with the first radio parameter has succeeded.

### (Supplementary Note 23)

The method according to any one of Supplementary Notes 19 to 21, further comprising starting direct communication with the second radio terminal in accordance with a second radio parameter specified by the network when direct discovery with the second radio terminal in accordance with the first radio parameter has succeeded.

### (Supplementary Note 24)

The method according to any one of Supplementary Notes 19 to 23, further comprising notifying the network of the first radio parameter or a frequency resource to be used for the sidelink communication determined based on the first radio parameter.

### (Supplementary Note 25)

The method according to any one of Supplementary Notes 19 to 24, further comprising sending to the network, in response to the request, a message indicating whether the first radio terminal can activate the sidelink communication.

### (Supplementary Note 26)

A method performed by a second radio terminal, the method comprising, when the second radio terminal cannot connect to a network, performing sidelink communication with a first radio terminal, which is in a state of being able to connect to the network, in accordance with a p re-con figured first radio parameter, wherein the sidelink communication comprises at least one of direct discovery and direct communication.

### (Supplementary Note 27)

The method according to Supplementary Note 26, wherein the first radio parameter is also used to perform the sidelink communication without assistance of the network when both the first radio terminal and the second radio terminal cannot connect to the network.

### (Supplementary Note 28)

The method according to Supplementary Note 26 or 27, wherein the first radio parameter is pre-configured in the second radio terminal or in a Universal Integrated Circuit Card (UICC) coupled to the second radio terminal.

### (Supplementary Note 29)

The method according to any one of Supplementary Notes 26 to 28, further comprising starting the sidelink communication with the first radio terminal in accordance with a second radio parameter specified by the network when the sidelink communication with the first radio terminal in accordance with the first radio parameter has succeeded,

### (Supplementary Note 30)

The method according to any one of Supplementary Notes 26 to 29, further comprising starting direct communication with the first radio terminal in accordance with a second radio parameter specified by the network when direct discovery with the first radio terminal in accordance with the first radio parameter has succeeded.

### (Supplementary Note 31)

A method performed by a control apparatus, the method comprising requesting a first radio terminal, which is in a state of being able to connect to a network, to start sidelink communication with a second radio terminal, which is in a state of being unable to connect to the network, in accordance with a pre-configured first radio parameter, wherein the sidelink communication comprises at least one of direct discovery and direct communication,

### (Supplementary Note 32)

The method according to Supplementary Note 31, wherein the first radio parameter is also used to perform the sidelink communication without assistance of the network when both the first radio terminal and the second radio terminal cannot connect to the network.

### (Supplementary Note 33)

The method according to Supplementary Note 31 or 32, wherein the first radio parameter is pre-configured in the first radio terminal or in a Universal Integrated Circuit Card (UICC) coupled to the first radio terminal.

### (Supplementary Note 34)

A program for causing a computer to perform a method in a first radio terminal, wherein

the method comprises, in response to receiving a request from a network when the first radio terminal can connect to the network, performing sidelink communication with a second radio terminal, which is in a state of being unable to connect to the network, in accordance with a pre-configured first radio parameter, and

the sidelink communication comprises at least one of direct discovery and direct communication.

### (Supplementary Note 35)

A program for causing a computer to perform a method In a second radio terminal, wherein

the method comprises, when the second radio terminal cannot connect to a network, performing sidelink communication with a first radio terminal, which is in a state of being able to connect to the network, in accordance with a pre-configured first radio parameter, and

the sidelink communication comprises at least one of direct discovery and direct communication.

### (Supplementary Note 36)

A program for causing a computer to perform a method In a control apparatus, wherein

the method comprises requesting a first radio terminal, which is in a state of being able to connect to a network, to start sidelink communication with a second radio terminal, which is in a state of being unable to connect to the network, in accordance with a pre-configured first radio parameter, and

the sidelink communication comprises at least one of direct discovery and direct communication.

This application is based upon and claims the benefit of priority from Japanese Patent Application No. 2015-045184, filed on Mar. 6, 2015, the disclosure of which is incorporated herein in Its entirety by reference.

### REFERENCE SIGNS LIST

1 RELAY USER EQUIPMENT (UE)
2 REMOTE UE
3 EVOLVED UNIVERSAL TERRESTRIAL RADIO ACCESS NETWORK (E-UTRAN)
4 EVOLVED PACKET CORE (EPC)
5 PROXIMITY-BASED SERVICES (ProSe) FUNCTION ENTITY
6 PROSE APPLICATION SERVER
31 EVOLVED NODEB (eNodeB)
32 CELL
100 PUBLIC LAND MOBILE NETWORK (PLMN)
102 INTER-UE DIRECT INTERFACE (SIDELINK)

1. A radio terminal apparatus comprising:
at least one radio transceiver; and
at least one processor coupled to the at least one radio transceiver, wherein
the at least one processor is configured to, in response to receiving a request from a network when the radio terminal apparatus can connect to the network, perform sidelink communication with a second radio terminal, which is in a state of being unable to connect to the network, in accordance with a pre-configured first radio parameter using the at least one radio transceiver, and
the sidelink communication comprises at least one of direct discovery and direct communication.

2. The radio terminal apparatus according to claim 1, wherein the first radio parameter is also used to perform the sidelink communication without assistance of the network when both the radio terminal apparatus and the second radio terminal cannot connect to the network.

3. The radio terminal apparatus according to claim 1, wherein the first radio parameter is pre-configured in the radio terminal apparatus or in a Universal Integrated Circuit Card (UICC) coupled to the radio terminal apparatus,

4. A radio terminal apparatus comprising:
at least one radio transceiver; and
at least one processor coupled to the at least one radio transceiver, wherein
the at least one processor is configured to, when the radio terminal apparatus cannot connect to a network, perform sidelink communication with a first radio terminal, which is in a state of being able to connect to the network, in accordance with a pre-configured first radio parameter using the at least one radio transceiver, and
the sidelink communication comprises at least one of direct discovery and direct communication,

5. The radio terminal apparatus according to claim 4, wherein the first radio parameter is also used to perform the sidelink communication without assistance of the network when both the radio terminal apparatus and the first radio terminal cannot connect to the network.

6. The radio terminal apparatus according to claim 4, wherein the first radio parameter is pre-configured in the radio terminal apparatus or in a Universal integrated Circuit Card (UICC) coupled to the radio terminal apparatus.

7. (canceled)

8. A method performed by a first radio terminal, the method comprising:
in response to receiving a request from a network when the first radio terminal can connect to the network, performing sidelink communication with a second radio terminal, which is in a state of being unable to connect to the network, in accordance with a pre-configured first radio parameter, wherein the sidelink communication comprises at least one of direct discovery and direct communication.

9. The method according to claim 8, wherein the first radio parameter is also used to perform the sidelink communication without assistance of the network when both the first radio terminal and the second radio terminal cannot connect to the network.

10. The method according to claim 8, wherein the first radio parameter is pre-configured In the first radio terminal or in a Universal integrated Circuit Card (UICC) coupled to the first radio terminal.

11-16. (canceled)

17. The radio terminal apparatus according to claim 1, wherein the at least one processor is configured to start the sidelink communication with the second radio terminal in accordance with a second radio parameter specified by the network when the sidelink communication with the second radio terminal in accordance with the first radio parameter has succeeded.

18. The radio terminal apparatus according to claim 1, wherein the at least one processor is configured to start direct communication with the second radio terminal In accordance with a second radio parameter specified by the network when direct discovery with the second radio terminal in accordance with the first radio parameter has succeeded.

19. The radio terminal apparatus according to claim 1, wherein the at least one processor is configured to notify the network of the first radio parameter or a frequency resource to be used for the sidelink communication determined based on the first radio parameter.

20. The radio terminal apparatus according to claim 1, wherein the at least one processor is configured to send to the network, in response to the request, a message indicating whether the radio terminal apparatus can activate the sidelink communication.

21. The radio terminal apparatus according to claim 1, wherein the request comprises an indication indicating which of the first radio parameter and a second radio parameter specified by the network should be used for the sidelink communication with the second radio terminal.

22. The radio terminal apparatus according to claim 21, wherein the at least one processor is configured to choose, in accordance with the indication, one of the first and second radio parameters to use for the sidelink communication.

23. The radio terminal apparatus according to claim 1, wherein the request is transmitted to the radio terminal apparatus from one of a base station in the network, a mobility management node in the network, an Operation Administration and Maintenance (OAM) server, and a control entity that controls network-assisted proximity-based service communication.

24. The radio terminal apparatus according to claim 4, wherein the at least one processor is configured to start the sidelink communication with the first radio terminal in accordance with a second radio parameter specified by the network when the sidelink communication with the first radio terminal in accordance with the first radio parameter has succeeded.

25. The radio terminal apparatus according to claim 4, wherein the at least one processor is configured to start direct communication with the first radio terminal in accordance with a second radio parameter specified by the network when direct discovery with the first radio terminal in accordance with the first radio parameter has succeeded.

26. The method according to claim 8, further comprising starting the sidelink communication with the second radio terminal In accordance with a second radio parameter specified by the network when the sidelink communication with the second radio terminal in accordance with the first radio parameter has succeeded.

27. The method according to claim 8, further comprising starting direct communication with the second radio terminal in accordance with a second radio parameter specified by the network when direct discovery with the second radio terminal in accordance with the first radio parameter has succeeded.
